(19) United States
(12) Patent Application Publication
(10) Pub. No.: US 2011/0161053 A1
(43) Pub. Date: Jun. 30, 2011

(54) SLOPE-BASED FAST INTRINSIC MODE FUNCTIONS DECOMPOSITION METHOD AND APPARATUS

(75) Inventors: Yi-Jung Wang, Kaohsiung City (TW); Guo-Zua Wu, Taichung City (TW); Chih-Chi Chang, Hsinchu City (TW); Oscal Tzyh-Chiang Chen, Chiayi County (TW)

(73) Assignee: INDUSTRIAL TECHNOLOGY RESEARCH INSTITUTE, Hsinchu (TW)

(21) Appl. No.: 12/651,387

(22) Filed: Dec. 31, 2009

(51) Int. Cl. G06F 15/00

(52) U.S. Cl. 702/189

(57) ABSTRACT

An apparatus for analyzing a physical signal representing a physical phenomenon is provided. The apparatus comprises an analog-to-digital converter, a slope calculator, a local extrema identifier, a residual signal constructor and an intrinsic mode function (IMF) extractor. The analog-to-digital converter is used to convert the physical signal into a plurality of data points. The slope calculator is used to calculate slope of each data point. The local extrema identifier is used to identify a plurality of local extrema of the slopes. The residual signal constructor is used to construct a residual signal of the physical signal from the data points corresponding to the local extrema of slopes. An IMF extractor is used to extract an intrinsic mode function indicative of an intrinsic oscillatory mode in the physical phenomenon by subtracting the residual signal from the physical signal. A method for analyzing a physical signal representing a physical phenomenon is provided.

### BACKGROUND

1. Technical Field

The disclosure relates to a computer implemented physical signal analysis method and apparatus, and in particular relates to a computer implemented method and apparatus for analyzing nonlinear, non-stationary physical signals.

2. Background

Analyzing physical signals, especially nonlinear and non-stationary signals, is a difficult problem confronting many fields. These industries have employed various computer implemented methods to process the physical signals taken from physical phenomena such as earthquakes, ocean waves, tsunamis, ocean surface elevation and wind. One of these methods is called Empirical Mode Decomposition (EMD).

An EMD method has been disclosed in U.S. Pat. No. 5,983,162, which is described as follows. FIG. 1 shows a physical signal 100 (taking wind speed for example) analyzed by an EMD method according to the patent. Before describing the EMD method in detail, the definition and physical meaning of Intrinsic Mode Function (IMF) will be discussed. A Intrinsic Mode Function is a function that satisfies the following two conditions: (a) in the whole data set in the physical signal, the number of extrema and the number of zero-crossings must either be equal or differ at most by one, and (b) at any point, the mean value of the envelope defined by the local maxima and the envelope defined by the local minima is zero. The term “Intrinsic Mode Function” is adopted because it represents the oscillation mode embedded in the physical signal. The EMD method for decomposing the physical signal into IMFs is described as follows.

FIGS. 2A and 2B shows a flowchart describing a computer implemented EMD method according to the prior art. Referring to both FIG. 1 and FIG. 2, the physical activity, process or phenomenon is sensed by an appropriate sensor in step S202. Then, the analog signal is converted to a digital domain suitable for computer processing in step S204, an A/D conversion step. Thereafter, the Sifting Process is applied in steps S206˜S216 to sift the physical signal 100 with the EMD method and thereby extract the intrinsic mode function (IMF). The Sifting Process begins with step S206 by identifying local maxima of the digitized physical signal from step S204. Then, the method constructs an upper envelope 120 of the physical signal 100 in step S208. The upper envelope 120 is shown in FIG. 1 using a dot-dashed line. The local minima of the physical signal 100 are identified in step S210. To complete the envelope, a lower envelope 130 is constructed from the local minima in step S212. The lower envelope 130 is shown in FIG. 1 using a dot-dashed line. From the upper and lower envelopes 120 and 130, an envelope mean 140 is determined in step S214. The envelope mean 140 is the mean value of the upper and lower envelopes 120 and 130. The EMD method generates the first component signal (not shown) in step S216 by subtracting the envelope mean 140 from the physical signal 100.

The Sifting Process S206˜S216 serves two purposes: to eliminate riding waves (not shown) and to make the wave profiles more symmetric. Toward these ends, the next iteration is then performed by repeatedly executing steps S206˜S216. In the next iteration, the EMD method treats the first component signal as the physical signal in step S220, and the second component signal (not shown) will be generated by subtracting the envelope mean from the first component signal. The repeating process mentioned above is called recursive sifting.

Although the second sifting may show great improvement in the signal with respect to the first sifting, the sifting process should be further repeated to ensure the configuration is stable. To guarantee that the IMF component retains enough physical sense of both amplitude and frequency modulations, a stopping criterion is employed to stop the generation of the next IMF component. Step S218 is a decision step that decides whether the stopping criteria has been satisfied. The preferred stopping criteria determines whether three successive component signals satisfy the definition of IMF. If three successive component signals all satisfy the definition of the IMF, then the Sifting Process is determined to have arrived at an IMF and should be stopped to step S222. If not, step S218, starts another iteration by proceeding to step S220 as described above. Alternatively, another stopping criteria could be used that determines whether successive component signal are substantially equal. If successive component signals are substantially equal, then the Sifting Process has arrived at an IMF and should be stopped by proceeding to step S222. If not, step S218 starts another iteration by proceeding to step S220 as described above.

The first IMF is generated after numerous iterations. Then, the first IMF is separated from the physical signal in step S222 to generate a residual signal. Step S223 determines whether the residual signal has more than 2 extrema. If not, all of the IMF's have been extracted and the Sifting Process is stopped by proceeding to step S225. If so, then additional IMF's may be extracted by continuing the process in step S224. In step S224, the residual signal will be further treated as the physical signal during next iteration to generate the next IMF and subjected to the same Sifting Process as described above.

Although the first IMF may be obtained by employing the EMD method discussed after iterations, however, below are some problems of the method:

(1) The recursive sifting process requires much resources for calculations, and is not suitable for real-time application;

(2) Predetermining the stop criteria is difficult. The difference between successive component signals require additional calculations which must be compared with a threshold. It is difficult to predetermine the threshold and the threshold often changes between different applications; and

(3) No closed-form analytic expressions are used.

### SUMMARY

The embodiment provide an apparatus for analyzing a physical signal representing a physical phenomenon. The apparatus comprises an analog-to-digital converter for converting the physical signal into a plurality of data points; a slope calculator for calculating slope of each data point; a local extrema identifier for identifying a plurality of local extrema of the slopes; and a residual signal constructor for constructing a residual signal of the physical signal from the data points corresponding to the local extrema of the slopes; and an intrinsic mode function (IMF) extractor for extracting an intrinsic mode function indicative of an intrinsic oscillatory mode in the physical phenomenon by subtracting the residual signal from the physical signal.

The embodiment further provide a method for analyzing a physical signal representing a physical phenomenon. The method comprises converting the physical signal into a plurality of data points by an analog-to-digital converter; calculating slope of each data point by a slope calculator; identifying a plurality of local extrema of the slopes by a local extrema identifier; constructing a residual signal of the physical signal from the data points corresponding to the local extrema of the slopes by a residual signal constructor; and extracting an intrinsic mode function (IMF) indicative of an intrinsic oscillatory mode in the physical phenomenon by subtracting the residual signal from the physical signal by an intrinsic mode function extractor.

A detailed description is given in the following embodiments with reference to the accompanying drawings.

### BRIEF DESCRIPTION OF THE DRAWINGS

The embodiment can be more fully understood by reading the subsequent detailed description and examples with references made to the accompanying drawings, wherein:

FIG. 1 shows a physical signal analyzed by an EMD method presented in the U.S. Pat. No. 5,983,162;

FIGS. 2A and 2B shows a flowchart describing a computer implemented EMD method without the process of intermittency test according to the prior art;

FIG. 3 shows the physical signal being analyzed by using the apparatus of the embodiment;

FIG. 4 is a schematic diagram of an apparatus of the embodiment for analyzing the physical signal;

FIG. 5 illustrates the physical signals being analyzed by the apparatus of the embodiment;

FIG. 6 is a flow chart of the method for analyzing a physical signal according to the embodiment.

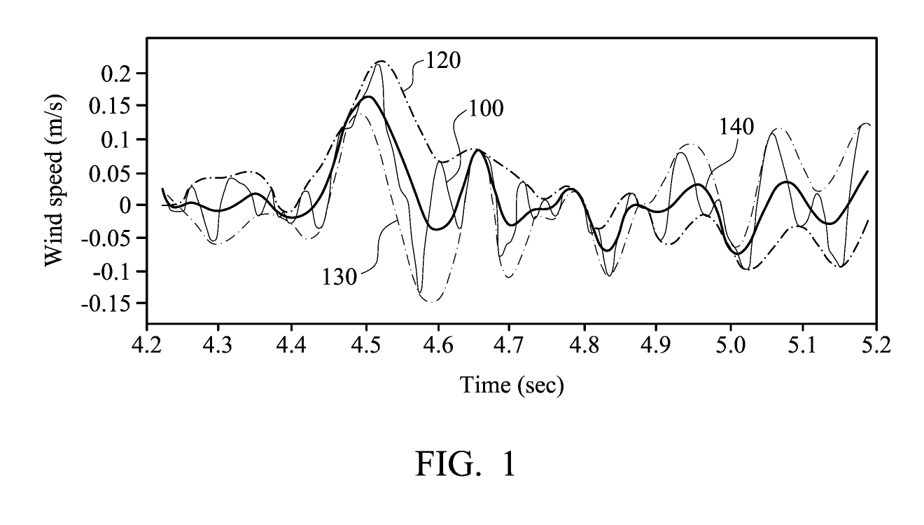

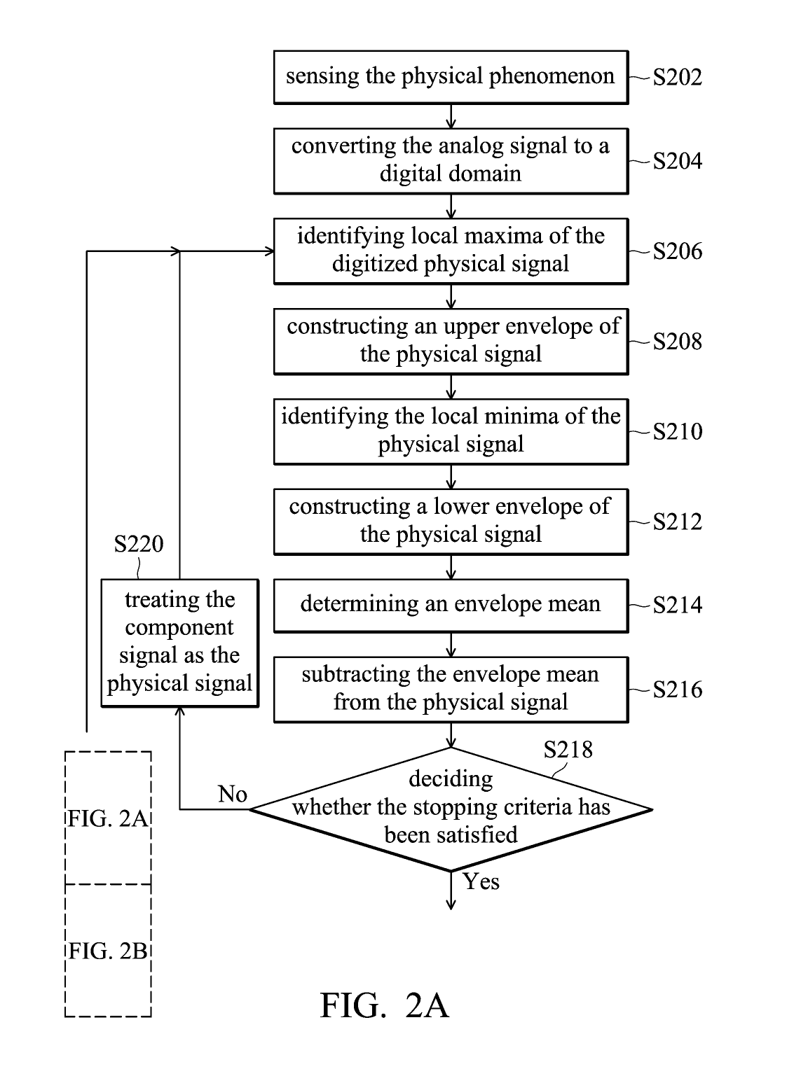

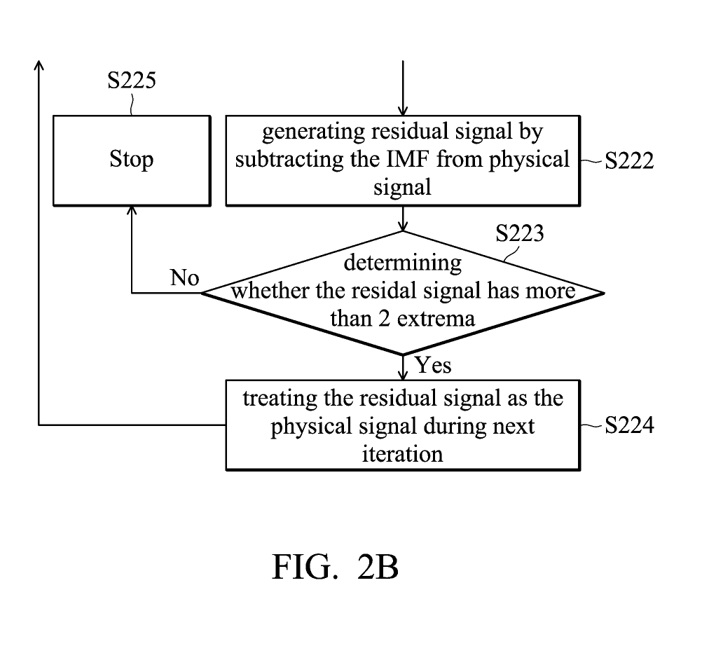

### DETAILED DESCRIPTION OF THE EMBODIMENT

The following description is of the best-contemplated mode of carrying out the embodiment. This description is made for the purpose of illustrating the general principles of the embodiment and should not be taken in a limiting sense. The scope of the embodiment is best determined by reference to the appended claims.

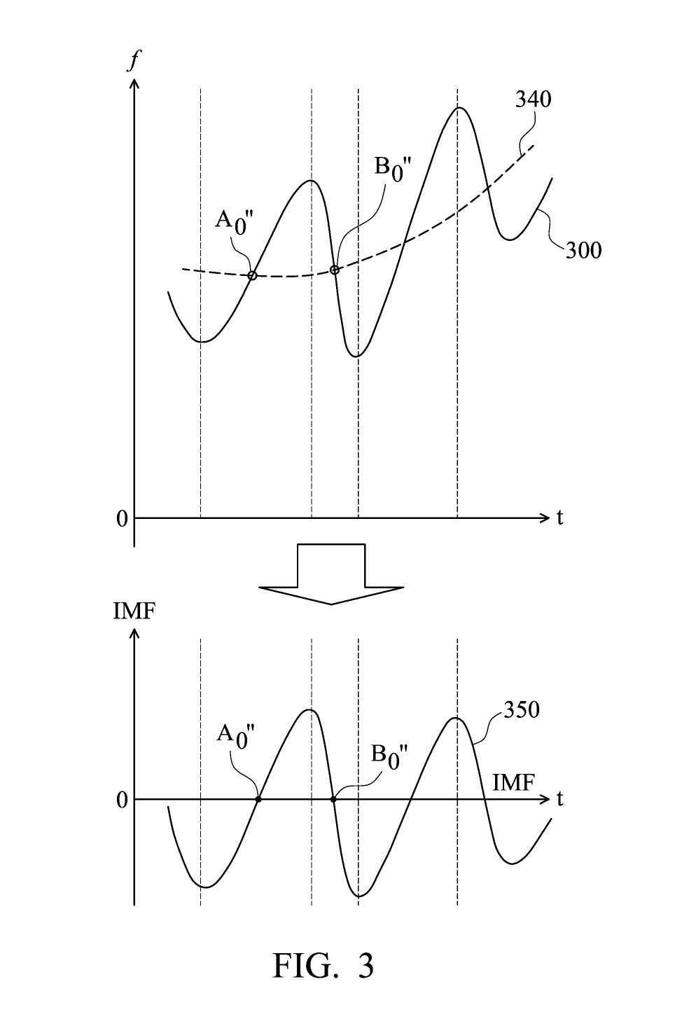

FIG. 3 shows the physical signal 300 being analyzed by using the apparatus of the embodiment. The physical signal 300 hereinafter may be referred to as geophysical signal representing a geophysical phenomenon, such as an earthquake, an ocean wave, an ocean surface elevation, or wind, a biological signal representing a biological phenomenon, a financial signal representing a financial phenomenon, an acoustical signal representing a sound, or an image signal which is two or three dimensional. Although a one-dimensional physical signal is discussed hereinafter, the embodiment is not limited thereto.

The physical signal 300 is usually nonlinear and non-stationary, may be decomposed into an intrinsic mode function (IMF) 350 and a residue signal 340 by the embodiment. The IMF 350 is indicative of an intrinsic oscillatory mode in the physical phenomenon, while the residue signal 340 is usually regarded as the result of various interferences. The purpose of the embodiment is to extract IMF 350 from the physical signal 300 fast.

In order to make the embodiment can be understood easily, the following derivation is approximated by the stationary signal, but should not be taken in a limiting sense.

The residue signal 340 and the IMF 350 may be respectively seen as a low frequency signal ƒ_{L} and a high frequency signal ƒ_{H}. Thus, (the physical signal ƒ may be expressed as:) Eqs. (1), (2) and (3) defines the stationarity as a function of frequency of physical signal ƒ,

ƒ=ƒ_{H}+ƒ_{L}+C (1)

where C is a DC component, and

$$\begin{matrix}{f}_{L} = {\sum }_{j = 1}^{m} ( {A}_{L , j} sin ( {ω}_{L , j} t + {θ}_{L , j} ) ) & ( 2 ) \\ {f}_{H} = {\sum }_{i = 1}^{n} ( {A}_{H , i} sin ( {ω}_{H , i} t + {θ}_{H , i} ) ) & ( 3 )\end{matrix}$$

where A_{L,j} and A_{H,i} are amplitudes, ω_{L,j} and ω_{H,i} are angular frequencies, θ_{L,j} and θ_{H,i} are phase angles, 1≦i≦n, and 1≦j≦m. Since the angular frequency ω_{H,i} is much greater than the angular frequency ω_{L,j}, the low frequency ƒ_{L} within the high frequency ƒ_{H} may be seen as a linear signal S_{L}·t+C_{L}. Therefore, the physical signal ƒ may be further expressed as:

$$\begin{matrix}f = {f}_{H} + {f}_{L} + C \\ = {\sum }_{i = 1}^{n} ( {A}_{H , i} sin ( {ω}_{H , i} t + {θ}_{H , i} ) ) + {\sum }_{j = 1}^{m} ( {A}_{L , j} sin ( {ω}_{L , j} t + {θ}_{L , j} ) ) + C \\ \approx {\sum }_{i = 1}^{n} ( {A}_{H , i} sin ( {ω}_{H , i} t + {θ}_{H , i} ) ) + {S}_{L} \cdot t + {C}_{T}\end{matrix} \qquad ( 4 )$$

where the C_{T} is total sum of all the constants. The process for analyzing the physical signal ƒ according to the embodiment will be discussed hereinafter.

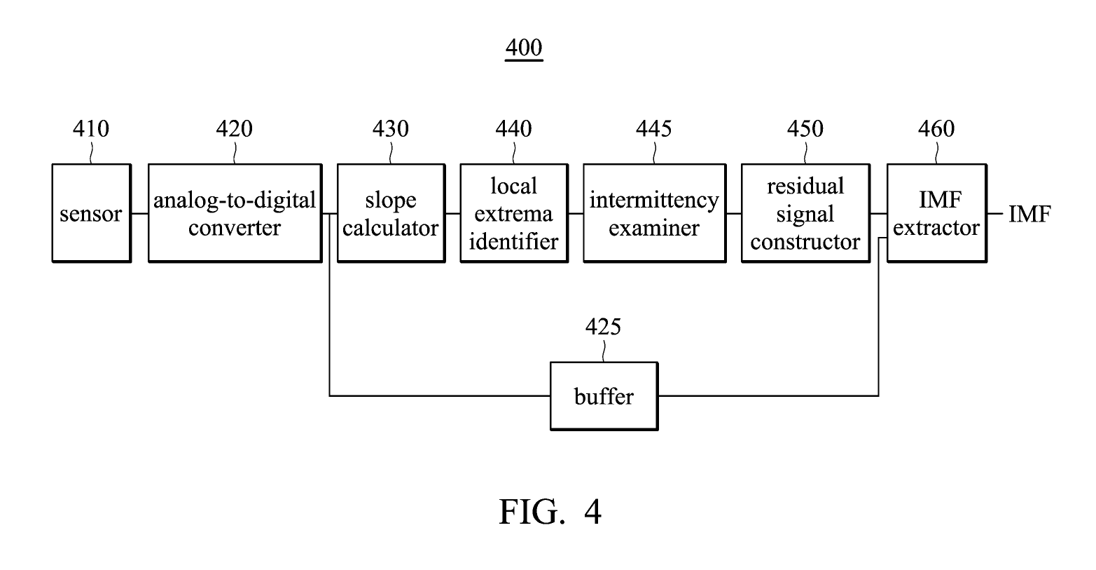

FIG. 4 is a schematic diagram of an apparatus 400 of the embodiment for analyzing the physical signal 300. The apparatus 400 of the embodiment for analyzing a physical signal 300 comprises a sensor 410, an analog-to-digital converter 420, a slope calculator 430, a local extrema identifier 440, an intermittency examiner 445, a residual signal constructor 450, a buffer 425 and an intrinsic mode function (IMF) extractor 460. The elements 410˜460 of the apparatus 400 is used to perform various processes for analyzing the physical signal 300, and these processes are described as follows.

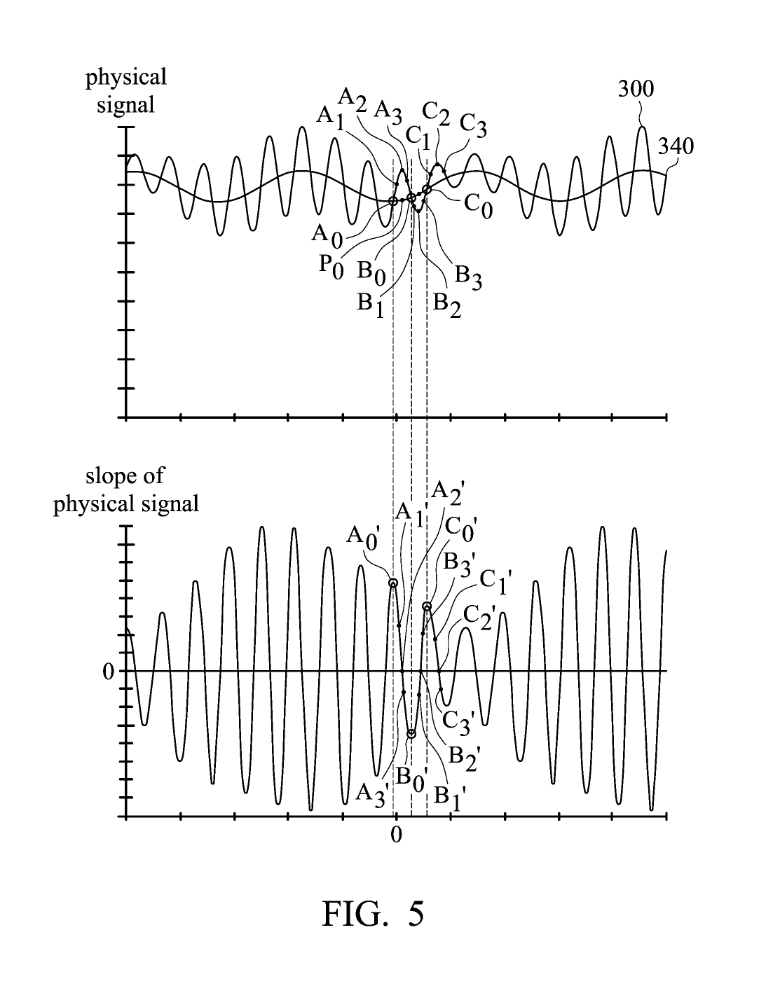

Please refer to FIG. 4 and FIG. 5, wherein FIG. 5 illustrates the physical signals 300 upon which the apparatus 400 of the embodiment is applied. First, the sensor 410 may sense the physical phenomenon and generate the physical signal 300. Then, the analog-to-digital converter (ADC) 420 coupled to the sensor 410 may convert the physical signal 300 into a plurality of discrete data points, such as A₀˜A₃, B₀˜B₃, and C₀˜C₃ as shown in FIG. 5. It is well known for those skilled in the art that the number of the data points depends on the sampling frequency that a user requires. In other words, the higher the sampling frequency is, the more the data points.

Next, the slope calculator 430 coupled to the ADC 420 may calculate slope of each data point, for example, the slopes A₀′˜A₃′, B₀′˜B₃′, C₀′˜C₃′ of data points A₀˜A₃, B₀˜B₃, and C₀˜C₃ respectively. For example, for three consecutive data points having ƒ_{t-Δt}, ƒₜ and ƒ_{t+Δt}, respectively, the slope Sₜ at data point ƒₜ may be expressed as:

$${S}_{t} = \frac{{f}_{t + Δ t} - {f}_{t - Δ t}}{2 \cdot Δ t} ,$$

where Δt is the time interval between the two data points. Then, the slopes of the data points are all calculated, as shown in the lower part of FIG. 5. In FIG. 5, each data point in the upper part of FIG. 5 corresponds to a slope in the lower part of FIG. 5. For example, data point A₀ corresponds to a slope A₀′, data point B₀ corresponds to a slope B₀′, and data point C₀ corresponds to a slope value C₀′, etc. For purposes of understanding the embodiment, the slope values in the lower part of FIG. 5 may be mathematically regarded as the first-order derivatives of the data points of the physical signal 300 shown in the upper part of FIG. 5. Derived from Eq. (4), the result from the slope calculator 430 may be expressed as:

$${f}^{′} \approx {\sum }_{i = 1}^{n} ( {A}_{H , i} {ω}_{H , i} cos ( {ω}_{H , i} t + {θ}_{H , i} ) ) + {S}_{L} \qquad ( 5 )$$

Next, the local extrema identifier 440 may identify a plurality of local extrema of the slopes. In this case, the local maxima A₀′ and C₀′ and the local minima B₀′ among the slopes, for example, may be identified by the local extrema identifier 440, as shown in FIG. 5. It is well known by those skilled in the art that a function has a local maximum value at point X, if there are no other adjacent points having a value greater than that of the point X, or has a local minimum value at point X if there are no other adjacent points having a value smaller than that of the point X. Mathematically, the local extrema A₀′, B₀′ C₀′ in the lower part of FIG. 5 are the points where the first-order derivatives of the slopes shown in the same part of FIG. 5 (or the second-order derivatives of the physical signal 300 shown in the upper part of FIG. 5) are equal to zero. Derived from Eq. (5), the local extrema of the slopes may be expressed as:

$${f}^{″} \approx - {\sum }_{i = 1}^{n} ( {{A}_{H , i} ( {ω}_{H , i} )}^{2} sin ( {ω}_{H , i} t + {θ}_{H , i} ) ) = 0 \qquad ( 6 )$$

Next, an intermittency test may be performed by the intermittency examiner 445. An IMF extracted from a physical signal should theoretically maintain a stable periodicity. Thus, the intervals between every two adjacent local extrema may be almost the same. Accordingly, by examining the intermittency of the local extrema, the intermittency examiner 445 may further insert the region failing said intermittency test by some extra local extrema of slopes.

Then, the residual signal 340 of the physical signal 300 may be constructed by using the residual signal constructor 450 based on the data points corresponding to the local extrema of slopes. For example, the data points A₀, B₀, and C₀ respectively corresponding to the local extrema A₀′, B₀′ and C₀′ of slopes as shown in FIG. 5 may be used. Those data points corresponding to the local extrema of the slopes are mathematically regarded as the points of inflection of the physical signal 300. For constructing a complete residual signal, additional points, e.g., point P₀ as shown in FIG. 5, may be required. Various methods such as interpolation and curve fitting may be used to obtain the additional points to construct the residual signal. Since the methods are well known to those skilled in the art, they will not be discussed further for brevity.

From FIG. 3 and FIG. 5, it can be seen that the data points corresponding to the local extrema of slopes (e.g. data points A₀ and B₀, which are corresponding to the local extrema A₀′ and B₀′ of slope, respectively) are located near to the zero-crossings A₀″ and B₀″ of the physical signal 300 as shown in FIG. 3. Refer to Eq. (6), suppose that ω_{H,i}= ω̅_{H}+δᵢ (where ω̅_{H} is the mean value of ω_{H,i}), and all of the angular frequencies within one IMF are almost equal to each other (that is, ω_{H,1}≈ω_{H,2}≈ . . . ≈ω_{H,n}), then

$${( \frac{{ω}_{H , i}}{{ϖ}_{H}} )}^{2} \approx 1.$$

When dividing both sides of Eq. (6) by ( ω̅_{H})², we get:

$${\sum }_{i = 1}^{n} ( {A}_{H , i} sin ( {ω}_{H , i} t + {θ}_{H , i} ) ) \approx 0. \qquad ( 7 )$$

When comparing Eq. (7) with Eq. (3), it is found that the local extrema of the slopes discussed above is close to the zero-crossings of the physical signal 300.

Finally, the IMF extractor 460, is coupled to the residual signal constructor 450 and the buffer 425. The buffer 425 coupled to the analog-to-digital converter 420 stores the digitized physical signal from the analog-to-digital converter 420. The buffer 425 can be embedded in the IMF extractor 460 (not shown in FIG. 4). The IMF extractor 460 subtracts the residual signal obtained from the residual signal constructor 450 from the physical signal 300 obtained from the buffer 425. As the result, the IMF 350 indicative of an intrinsic oscillatory mode in the physical phenomenon is extracted and obtained.

The residual signal 340 in FIG. 3 or FIG. 5 is the low frequency signal relative to the frequency of IMF and can be expressed as a linear signal S_{C}·t+C_{C}, where the subscript C stands for “constructed signal”. By subtracting the residual signal 340 from the physical signal 300, the equation of IMF can be expressed as:

IMF=ƒ−(S_{C}·t+C_{C}) (8)

It can be derived easily that the second derivative of Eq. (8) is as follows:

IMF″=ƒ″ (9)

From Eq. (9) it can be seen that the data points corresponding to the extrema of slopes of the IMF are the same points of A₀, B₀ and C₀ shown in FIG. 5 and independent of the characteristics of the function ƒ. In other words, if IMF is treated as a new physical signal and performs the next iteration (steps S630˜S660 which will be discussed in the following paragraph) to obtain a new IMF, the new IMF should be equal to the previous IMF. That is the reason why the embodiment does not require multiple iterations of calculations to obtain an IMF, while the prior art needs numerous recursive sifting processes.

The residual signal may be treated as a new physical signal during next iteration to generate a next IMF. The apparatus for analyzing physical signals representative of a physical phenomenon is completely introduced.

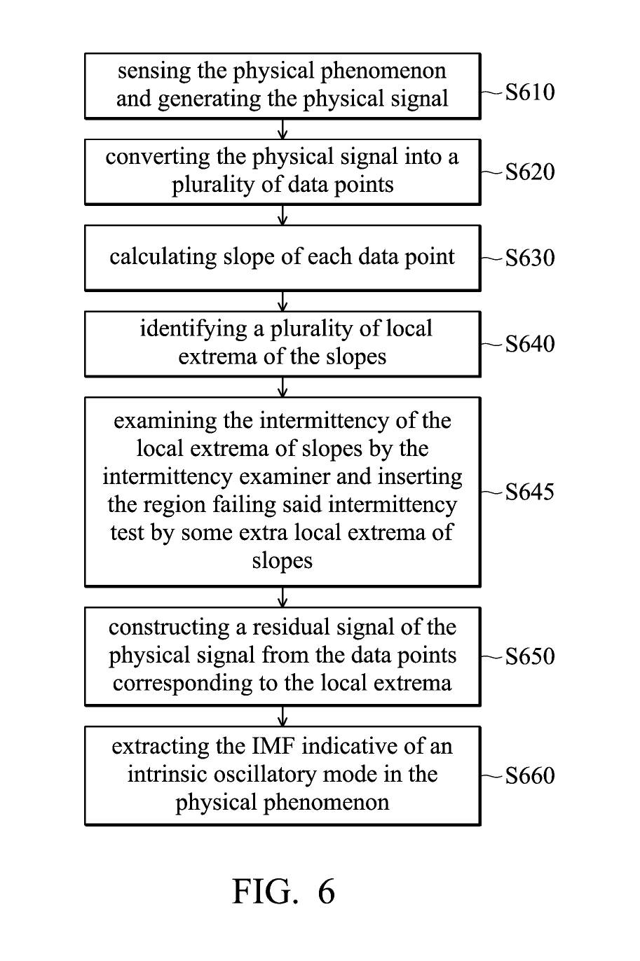

The embodiment further provide a method for analyzing a physical signal 300 representing a physical phenomenon. FIG. 6 is a flow chart of the method for analyzing a physical signal 300 according to one embodiment of the embodiment. With reference to FIG. 6, FIG. 5 and FIG. 4, the method of the embodiment comprises: in step S610, sensing the physical phenomenon and generating the physical signal 300 by the sensor 410; in step S620, converting the physical signal 300 into a plurality of data points, for example, data points A₀˜A₃, B₀˜B₃, C₀˜C₃, by the analog-to-digital converter 420; in step S630, calculating slope of each data point by the slope calculator 430, for example, the slopes A0′˜A3′, B0′˜B3′, C0′˜C3′ of the data points A0˜A3, B0˜B3, and C0˜C3 respectively, by the slope calculator 430; in step S640, identifying a plurality of local extrema of the slopes, for example, A₀′, B₀′ and C₀′, by the local extreme identifier 440; in step S645, examining the intermittency of the local extrema of slopes by the intermittency examiner 445 and inserting the region failing said intermittency test by some extra local extrema of slopes; in step S650, constructing a residual signal 340 of the physical signal 300 from the data points corresponding to the local extrema of slopes, for example, data points A₀, B₀ and C₀ corresponding to A₀′, B₀′ and C₀′ respectively, by the residual signal constructor 450; and in step S660, extracting the IMF 350 indicative of an intrinsic oscillatory mode in the physical phenomenon by subtracting the residual signal 340 from the physical signal 300 by the intrinsic mode function extractor 460. The method of the embodiment further comprises treating the residual signal as a new physical signal and repeating the foregoing steps S630-S660 during next iteration to generate a next IMF (not shown).

The embodiment does not require recursive calculations, thus saving resources and is suitable for real-time application. The method of the embodiment performs step S610˜S660 once to obtain the IMF of the physical signal. Suppose that the calculations for constructing an upper envelope or lower envelope in the prior art is E, which is substantially equal to calculations for constructing the residual signal in the embodiment and is much greater than that for other processes. If the recursive sifting process is repeated for n times in the prior art, then the calculations for the embodiment is about

$$\frac{1}{2 \cdot n} ( \frac{E}{2 \cdot n \cdot E} = \frac{1}{2 \cdot n} )$$

of that in the prior art.

Since the embodiment does not require recursive sifting processes, the stop criteria for the recursive sifting processes is not required.

The time for analyzing physical signals according to the embodiment may be more predictive.

The embodiment is to remove a residual signal from a physical signal and obtain an IMF rapidly and efficiently.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An apparatus for analyzing a physical signal representing a physical phenomenon, comprising:
an analog-to-digital converter for converting the physical signal into a plurality of data points;
a slope calculator for calculating slope of each data point;
a local extrema identifier for identifying a plurality of local extrema of the slopes; and
a residual signal constructor for constructing a residual signal of the physical signal from the data points corresponding to the local extrema; and
an intrinsic mode function (IMF) extractor for extracting an intrinsic mode function indicative of an intrinsic oscillatory mode in the physical phenomenon by subtracting the residual signal from the physical signal.

2. The apparatus for analyzing a physical signal representing a physical phenomenon according to claim 1, further comprising a sensor for sensing the physical phenomenon and generating the physical signal.

3. The apparatus for analyzing a physical signal representing a physical phenomenon according to claim 1, further comprising an intermittency examiner for inserting some extra local extrema of slopes by examining the intermittency of the local extrema of slopes.

4. The apparatus for analyzing a physical signal representing a physical phenomenon according to claim 1, wherein the residual signal constructor constructs the residual signal by interpolation based on the data points corresponding to the local extrema of slopes.

5. The apparatus for analyzing a physical signal representing a physical phenomenon according to claim 1, wherein the residual signal constructor constructs the residual signal by curve fitting based on the data points corresponding to the local extrema of slopes.

6. A method for analyzing a physical signal representing a physical phenomenon, comprising:
converting the physical signal into a plurality of data points by an analog-to-digital converter;
calculating slope of each data point by a slope calculator;
identifying a plurality of local extrema of the slopes by a local extrema identifier;
constructing a residual signal of the physical signal from the data points corresponding to the local extrema of slopes by a residual signal constructor; and
extracting an intrinsic mode function (IMF) indicative of an intrinsic oscillatory mode in the physical phenomenon by subtracting the residual signal from the physical signal by an intrinsic mode function extractor.

7. The method for analyzing a physical signal representing a physical phenomenon according to claim 6, further comprising:
sensing the physical phenomenon and generating the physical signal by a sensor.

8. The method for analyzing a physical signal representing a physical phenomenon according to claim 6, further comprising:
inserting some extra local extrema of slopes by examining the intermittency of the local extrema by an intermittency examiner.

9. The method for analyzing a physical signal representing a physical phenomenon according to claim 6, further comprising:
constructing the residual signal by interpolation based on the data points corresponding to the local extrema of slopes by the residual signal constructor.

10. The method for analyzing a physical signal representing a physical phenomenon according to claim 6, further comprising:
constructing the residual signal by curve fitting based on the data points corresponding to the local extrema by the residual signal constructor.

11. The method for analyzing a physical signal representing a physical phenomenon according to claim 6, further comprising treating the residual signal as a new physical signal during next iteration to generate a next IMF.
